(19) United States
(12) Patent Application Publication
(10) Pub. No.: US 2013/0266842 A1
(43) Pub. Date: Oct. 10, 2013

(54) Lithium Ion Cell

(71) Applicants: Thomas Woehrle, Stuttgart-Feuerbach (DE); Joachim Fetzer, Bad-Ditzenbach (DE); Stephan Leuthner, Leonberg (DE)

(72) Inventors: Thomas Woehrle, Stuttgart-Feuerbach (DE); Joachim Fetzer, Bad-Ditzenbach (DE); Stephan Leuthner, Leonberg (DE)

(21) Appl. No.: 13/704,610

(22) PCT Filed: May 10, 2011
(86) PCT No.: PCT/EP11/57510

§ 371 Date: Mar. 7, 2013

(30) Foreign Application Priority Data
Jun. 17, 2010 (DE) 102010030197.3

(51) Int. Cl. H01M 2/16

(52) U.S. Cl. CPC H01M 2/164
USPC 429/144; 429/246; 429/188; 429/231.8

(57) ABSTRACT

A lithium-ion cell includes a negative electrode, a positive electrode, and a separator arranged between the negative electrode and the positive electrode. In order to increase the mechanical stability of the separator and in the process to negatively influence the electrical power of the lithium-ion cell as little as possible, the separator includes at least one inorganic solid electrolyte layer conducting lithium ions.

The present invention relates to an electrochemical element, in particular a lithium ion cell, a separator for an electrochemical element, in particular a lithium ion cell, and also the use thereof.

### PRIOR ART

For the purposes of the present invention, lithium ion cells, also referred to as lithium ion polymer cells or lithium polymer cells or as corresponding batteries, accumulators or systems, are electrochemical elements which have a negative electrode having an intercalation structure, for example graphite, into which or from which lithium ions can be reversibly intercalated or deintercalated, i.e. incorporated or removed.

Lithium ion cells usually have a separator composed of a plastic, usually a polyolefin-based plastic, between the electrodes. However, a problem associated with such plastic separators is that they can shrink and melt at high temperatures, for example if internal short circuits occur. The plastic separator can thus no longer separate the electrodes from one another over their full area and a chain reaction of further internal short circuits can commence. This is referred to as “runaway” or “thermal runaway” of the lithium ion cell.

DE 10 2004 018 930 A1 states that the effects of this can be reduced by a separator composed of a polymeric substrate material and an inorganic substrate material, since in such a separator the inorganic substrate material does not melt or shrink.

### DISCLOSURE OF THE INVENTION

The present invention provides an electrochemical element, in particular a lithium ion cell, which comprises a negative electrode (anode), a positive electrode (cathode) and a separator arranged between the negative electrode and the positive electrode. According to the invention, the separator comprises at least one inorganic solid-state electrolyte which conducts lithium ions.

For the purposes of the present invention, a “lithium ion cell”, which can also be referred to as lithium ion polymer cell or lithium polymer cell or as corresponding battery, accumulator or system, can be, in particular, an electrochemical element which has a negative electrode having an intercalation structure, for example graphite, into which or from which lithium ions can be reversibly intercalated or deintercalated, i.e. incorporated or removed. For the purposes of the present invention, a “lithium ion cell” does not comprise a liquid or molten electrolyte. Electrochemical elements which, for example, have a metallic negative electrode, for example an electrode composed of metallic lithium or a metallic lithium alloy, for example lithium-sulfur batteries/accumulators, are particularly not considered to be “lithium ion cells”.

For the purposes of the present invention, an “inorganic solid-state electrolyte which conducts lithium ions” can be, in particular, an inorganic solid whose material itself conducts lithium ions. The inorganic solid-state electrolyte which conducts lithium ions preferably does not comprise any liquid or any polymer. In particular, the expression “inorganic solid-state electrolyte which conducts lithium ions” does not encompass an inorganic solid whose material itself does not conduct lithium ions and contains, for example, a liquid which conducts lithium ions or a polymer which conducts lithium ions.

For the purposes of the present invention, the term “lanthanides” refers, in particular, to the group consisting of lanthanum, cerium, praseodymium, neodymium, promethium, samarium, europium, gadolinium, terbium, dysprosium, holmium, erbium, thulium, ytterbium and lutetium.

Inorganic solid-state electrolyte layers which conduct lithium ions advantageously have a high mechanical, electrochemical, thermal, vibration and shock stability and do not melt or change their shape at elevated operating temperatures. Thus, inorganic solid-state electrolyte layers which conduct lithium ions can prevent “runaway” of the electrochemical element.

Compared to conventional inorganic material layers which do not conduct lithium ions, for example layers of sintered aluminum oxide (Al₂O₃), in which lithium ions have to diffuse around the inorganic material which does not conduct lithium ions (see FIG. 5), solid-state electrolyte layers according to the invention have the advantage that lithium ions can diffuse through the material which conducts lithium ions of the solid-state electrolyte layer (see FIG. 6). The diffusion paths for the lithium ions can be shortened in this way. This in turn has an advantageous effect on the internal resistance and the high-current capability of the electrochemical element.

The inorganic solid-state electrolyte layer which conducts lithium ions can, in particular, be ceramic.

In an embodiment, the at least one inorganic solid-state electrolyte layer which conducts lithium ions does not conduct electrons or is an insulator in respect of electrons. In this way, the solid-state electrolyte layer can be used as such, i.e. without further layers which do not conduct electrons or are insulators in respect of electrons, for example polymer layers, as separator.

In a further embodiment, the at least one inorganic solid-state electrolyte layer which conducts lithium ions comprises a lithium ion-conducting compound of the perovskite type, in particular a perovskite type having A vacancies. Such compounds can advantageously have a lithium ion conductivity at room temperature of 10⁻³ S/cm.

In a further embodiment, the at least one inorganic solid-state electrolyte layer which conducts lithium ions comprises at least one lithium lanthanide titanate of the perovskite type (LLTO). Such compounds can advantageously have a lithium ion conductivity at room temperature of 10⁻³ S/cm.

In a further embodiment, the at least one inorganic solid-state electrolyte layer which conducts lithium ions comprises at least one lithium lanthanide titanate of the perovskite type (LLTO) having the general formula (1):

Li₃ₐLn_{(2/3)-a(1/3)-2a}TiO₃ or Li₃ₐLn_{0.67-a}TiO₃,

where Ln is a lanthanide or a mixture of a plurality of lanthanides, in particular lanthanum, and 0<a≦0.16, in particular 0.04≦a≦0.15, preferably a=0.1 or a=0.11. For example, the at least one inorganic solid-state electrolyte layer which conducts lithium ions can comprise Li_{0.3}La_{0.57}TiO₃. Such compounds can advantageously have a lithium ion conductivity at room temperature of 10⁻³ S/cm.

Lithium lanthanum titanates of the perovskite type can, for example, be prepared in a solid-state synthesis, for example from Li₂CO₃, La₂O₃ and TiO₂ (anatase), at temperatures above 600° C., for example firstly at 650° C. for 2 hours and subsequently at 800° C. for 12 hours. The product can subsequently be milled and pressed. The product is then preferably sintered/heat treated, for example at 1300° C. for 1 hour. The lithium ion conductivity can advantageously be increased by the heat treatment. Lithium lanthanum titanates of the perovskite type which have been prepared in this way are preferably quenched, i.e. cooled rapidly, after the heat treatment. The lithium ion conductivity can be increased further in this way.

However, lithium lanthanum titanates of the perovskite type can also be prepared in a sol-gel synthesis, for example from La(NO₃)₃.6H₂O and LiNO₃ in water and Ti(OC₃H₇)₄ in 1-propanol, for example firstly at 700° C. for gel formation, subsequently at 95° C. for 5 hours and/or at 100° C. for 12 hours for drying, then at 400-700° C. for 12 hours for decomposition. The product is then preferably sintered/heat treated, for example at 1300° C. for 1 hour. The lithium ion conductivity can advantageously be increased by the heat treatment. Lithium lanthanum titanates of the perovskite type which have been prepared in this way are preferably cooled slowly, for example at a cooling rate of 100° C./h, after the heat treatment. The lithium ion conductivity can be increased further in this way.

In a further embodiment, the at least one inorganic solid-state electrolyte layer which conducts lithium ions comprises a lithium ion-conducting compound of the NASICON type (NASICON: “sodium super-ionic conductor”). In particular, the at least one inorganic solid-state electrolyte layer which conducts lithium ions can be a lithium ion-conducting compound of the NASICON type having the general formula (2):

A_{1+b}[M¹_{2-b}M²_{b}(PO₄)₃]

where
A is a monovalent element or a mixture of a plurality of monovalent elements, in particular Li and/or Na,
M¹ is a tetravalent element or a mixture of tetravalent elements, in particular Ge, Ti, Zr or a mixture thereof,
M² is a trivalent element or a mixture of trivalent elements, in particular Al, Cr, Ga, Fe, Sc, In, Lu, Y, La or a mixture thereof,
   and 0≦b≦1. Examples are LiGe₂(PO₄)₃ and Li_{1.3}Al_{0.3}Ti_{1.7}(PO₄)₃ (LATP). Such compounds can advantageously have a lithium ion conductivity at room temperature of 3·10⁻³ S/cm. The lithium ion conductivity can be increased by, in particular, trivalent cations which are smaller than aluminum ions.

In a further embodiment, the at least one inorganic solid-state electrolyte layer which conducts lithium ions comprises a lithium ion-conducting compound of the LiSICON type (LiSICON: “lithium super-ionic conductor”) or the thio-LiSICON type or of the γ-Li₃PO₄ type. For example, the at least one inorganic solid-state electrolyte layer which conducts lithium ions can be a lithium germanate, in particular of the general formula (3): Li_{2+2c}Zn_{1-c}GeO₄ where 0<c<1, for example Li₁₄ZnGe₄O₁₆, and/or a lithium germanium sulfide, in particular of the Li₂S—Ga₂S₃—GeS₂ type or of the general formula (4): Li_{4+d}Ge_{1-d}Ga_{d}S₄ where 0.15≦d≦0.35, and/or a lithium germanium/silicon/phosphorus sulfide, in particular of the general formula (5): Li₄₋ₑ(Ge/Si)₁₋ₑPₑS₄ where 0.5≦e≦1, for example Li_{3.25}Ge_{0.25}P_{0.75}S₄ or Li_{3.4}Si_{0.4}P_{0.6}S₄ (6.4·10⁻⁴ S/cm). Such compounds can advantageously have a lithium ion conductivity at room temperature of 10⁻⁴ S/cm.

In a further embodiment, the at least one inorganic solid-state electrolyte layer which conducts lithium ions comprises a lithium ion-conducting compound of the garnet type. In particular, the at least one inorganic solid-state electrolyte layer which conducts lithium ions can be a lithium ion-conducting compound of the garnet type having the general formula (7):

Li_{5+f+2g}Ln_{3-f}M³_{f}M⁴_{g}M⁵_{2-g}O₁₂

where
Ln is a lanthanide or a mixture of a plurality of lanthanides, in particular La, Pr, Nd, Sm, Eu or a mixture thereof,
M³ is a divalent element or a mixture of a plurality of divalent elements, in particular Ba, Sr, Ca or a mixture thereof,
M⁴ is a trivalent element or a mixture of a plurality of trivalent elements, in particular indium,
M⁵ is a pentavalent element or a mixture of a plurality of trivalent elements, in particular Ta, Nb, Sb or a mixture thereof,
   and 0≦f≦1 and 0≦g≦0.35. For example, the at least one inorganic solid-state electrolyte layer which conducts lithium ions can comprise Li₅La₃Ta₂O₁₂. Li₆La₂BaTa₂O₁₂, Li_{5.5}La₃Nb_{1.75}In_{0.25}O₁₂, Li₅(La/Pr/Nd/Sm/Eu)₃Sb₂O₁₂ and/or Li₆Sr(La/Pr/Nd/Sm/Eu)₂Sb₂O₁₂. Such compounds can advantageously have a lithium ion conductivity at room temperature of 10⁻⁴ S/cm.

In a further embodiment, the at least one inorganic solid-state electrolyte layer which conducts lithium ions comprises a lithium ion-conducting composite. In particular, the at least one inorganic solid-state electrolyte layer which conducts lithium ions can comprise a lithium ion-conducting composite composed of at least one lithium ion-conducting compound, for example LiI and/or Li₂O, and at least one, in particular mesoporous, compound which does not conduct lithium ions, for example Al₂O₃ and/or B₂O₃. Such compounds can advantageously have a lithium ion conductivity at room temperature of 10⁻⁴ S/cm.

In a further embodiment, the at least one inorganic solid-state electrolyte layer which conducts lithium ions comprises an amorphous, inorganic lithium ion-conducting compound. In particular, the at least one inorganic solid-state electrolyte layer which conducts lithium ions can comprise a mechanically treated, in particular (ball-)milled, amorphous, inorganic, lithium ion-conducting compound, for example ball-milled LiNbO₃ or LiTaO₃. Such compounds can have a lithium ion conductivity at room temperature of 3·10⁻⁶ S/cm. As an alternative thereto or in addition thereto, the at least one inorganic solid-state electrolyte layer which conducts lithium ions can comprise a lithium ion-conducting, oxide- and/or sulfur-based glass, for example GeS₂—Li₂S—LiI doped with Ga₂S₃ and/or LaS₃ or Li₂S—SiS₂ doped with P₂S₅ and/or LiI and/or Li₄SiO₄. Such compounds can advantageously have a lithium ion conductivity at room temperature of 10⁻³ S/cm.

In a further embodiment, the at least one inorganic solid-state electrolyte layer which conducts lithium ions comprises a lithium ion-conducting compound of the LiPON type (LiPON: “lithium phosphorus oxynitride”), for example Li_{2.88}PO_{3.73}N_{0.14}. Li_{3.0}PO_{2.0}N_{1.2}, or a lithium ion-conducting compound of the LiSON type (LiSON: “lithium sulfur oxynitride”), for example Li_{0.29}S_{0.28}O_{0.35}N_{0.09}, or a lithium ion-conducting compound of the LiPOS type (LiPOS: “lithium phosphorus oxysulfide”), for example 6LiI-4Li₃PO₄—P₂S₅, or a lithium ion-conducting compound of the LiBSO type (LiBSO: “lithium borate sulfate” or “lithium borate-lithium sulfate glass”), for example of the general formula (8): (1−h)LiBO₂-hLi₂SO₄, where 0<h<1, for example 0.3LiBO₂-0.7Li₂SO₄, or a lithium ion-conducting compound of the LiSIPON type (LiSIPON: “lithium silicon phosphorus oxynitride”), for example Li_{2.9}Si_{0.45}PO_{1.6}N1.3₄. Such compounds can advantageously have a lithium ion conductivity at room temperature of 10⁻⁵ S/cm.

In a further embodiment, the at least one inorganic solid-state electrolyte layer which conducts lithium ions is porous. In particular, the at least one inorganic solid-state electrolyte layer which conducts lithium ions can have a porosity, in particular an open porosity, of from ≧5% to ≦90%, for example from ≧25% to ≦75%, for example about 50%.

In a further embodiment, the at least one inorganic solid-state electrolyte layer which conducts lithium ions has a lithium ion conductivity at room temperature of at least 1·10⁻⁷ S/cm, in particular at least 1·10⁻⁶ S/cm, for example at least 1·10⁻⁵ S/cm or 1·10⁻⁴ S/cm, preferably at least 5·10⁻⁴ S/cm, for example at least 1·10⁻³ S/cm.

The at least one inorganic solid-state electrolyte layer which conducts lithium ions can, for example, have a layer thickness d_{F} of from ≧0.1 μm to ≦50 μm, for example from ≧0.5 μm to ≦15 μm, for example about 5 μm.

Furthermore, the separator preferably comprises at least one polymer layer. The mechanical stability of the separator can be increased advantageously and cost-effectively by means of an additional polymer layer. Thus, the material of the inorganic solid-state electrolyte layer which conducts lithium ions and the associated materials costs can once again be minimized. In addition, polymer layers can advantageously have a high chemical and electrochemical long-term stability (over years) and thus increase the overall mechanical, chemical and electrochemical stability of the separator. Furthermore, such a separator can be produced in a simple way by coating a polymer layer with an inorganic solid-state electrolyte layer which conducts lithium ions or by coating an inorganic solid-state electrolyte layer which conducts lithium ions with a polymer layer. As an alternative thereto or in addition thereto, the negative electrode and/or the positive electrode, in particular the positive electrode, can be coated with an inorganic solid-state electrolyte layer which conducts lithium ions or with a polymer layer. The inorganic solid-state electrolyte layer which conducts lithium ions or the polymer layer can then in turn be coated with a polymer layer or an inorganic solid-state electrolyte layer which conducts lithium ions, respectively. This can be repeated a number of times. Finally, the last of these layers can be coated with the other (negative or positive) electrode or be given a different shape. In order to avoid a chemical reaction between the material of the inorganic solid-state electrolyte layer which conducts lithium ions and the material of the negative and/or positive electrode, it can optionally be advantageous firstly to coat the negative electrode and/or the positive electrode with a polymer layer.

The polymer layer can, for example, be a polyolefin-based polymer layer. Furthermore, the polymer layer can be porous. The porosity of polymer layers can advantageously be set in a defined manner in a simple way, for example by means of a stretching process. The polymer layer can also conduct lithium ions. The polymer layer preferably does not conduct electrons. For example, the polymer layer can have a layer thickness d_{F} of from ≧1 μm to ≦100 μm, for example from ≧10 μm to ≦40 μm, for example about 25 μm.

The separator is preferably configured and arranged in such a way that the at least one inorganic solid-state electrolyte layer which conducts lithium ions physically separates the negative electrode and the positive electrode from one another. For example, the at least one inorganic solid-state electrolyte layer which conducts lithium ions can for this purpose have the same area as the negative electrode and the positive electrode and be arranged parallel to these surfaces between the negative electrode and the positive electrode. In particular, the separator can be configured and arranged in such a way that the at least one inorganic solid-state electrolyte layer which conducts lithium ions and the at least one polymer layer in each case physically separate the negative electrode and the positive electrode from one another. For example, both the at least one inorganic solid-state electrolyte layer which conducts lithium ions and the at least one polymer layer can have the same areas as the negative electrode and/or positive electrode and in each case be arranged parallel to these surfaces between the negative electrode and positive electrode.

In a further embodiment, the separator comprises a layer system composed of at least one inorganic solid-state electrolyte layer which conducts lithium ions and at least one polymer layer. This has the advantage that the solid-state electrolyte layer increases the mechanical stability and does not melt or deform (shrink) at elevated operating temperatures and an internal short circuit can be avoided in this way. For example, the layers can be arranged alternately. The at least one inorganic solid-state electrolyte layer which conducts lithium ions is preferably arranged between the polymer layer and at least one of the electrodes, in particular the positive electrode. In particular, the polymer layer can be provided on one or both sides with at least one inorganic solid-state electrolyte layer which conducts lithium ions.

In a further embodiment, the polymer layer is provided with an inorganic solid-state electrolyte layer which conducts lithium ions on at least the side facing the positive electrode. This is because the active material of the positive electrode in the delithiated state, i.e. when the cell is fully charged, becomes unstable and can decompose, particularly at high temperatures, for example above 150° C., which can initialize “runaway”. As an alternative or in addition thereto, the separator can comprise a layer system composed of at least one inorganic solid-state electrolyte layer which conducts lithium ions and at least two polymer layers, with at least one inorganic solid-state electrolyte layer which conducts lithium ions being arranged between two polymer layers.

In a further embodiment, the negative electrode is an intercalation electrode. For example, the negative electrode can comprise natural or synthetic graphite, carbon nanotubes, soft carbon and/or hard carbon, in particular graphite, as intercalation material. In addition, the negative electrode can comprise other electrochemically active additives such as graphene, titanium, silicon, germanium, tin, lead, antimony, bismuth, zinc, cadmium, in metallic form, in the form of alloys and/or in the form of compounds and/or salts, for example in the form of oxides, hydroxides, carbides, nitrides, sulfides, phosphides, selenides, tellurides, antimonides, in particular silicon or nanosilicon. For example, the negative electrode can in this case comprise from ≧0% by weight to ≦30% by weight, for example from ≧5% by weight to ≦20% by weight, of silicon, for example from ≧5% by weight to ≦10% by weight, of additives and from ≧70% by weight to ≦100% by weight, for example from ≧80% by weight to ≦95% by weight, for example from ≧90% by weight to ≦95% by weight, of intercalation material, where the sum of the percentages by weight of intercalation material and the additives together is 100% by weight. In addition, the negative electrode can comprise a binder, known as an electrode binder. For example, the binder can comprise at least one polymer selected from the group consisting of polyvinylidene fluoride (PVdF), polyvinylidene-hexafluoropropylene copolymer (PVdF-HFP), cellulose or polystyrene-butadiene copolymer and mixtures thereof. For example, the binder can be an electrode binder based on polyvinylidene fluoride, polyvinylidene-hexafluoropropylene copolymer, cellulose and/or polystyrene-butadiene copolymer. The negative electrode can, for example, have a layer thickness d_{N} of from ≧20 μm to ≦300 μm, for example from ≧30 μm to ≦200 μm, for example about 120 μm.

The positive electrode can comprise, for example, lithium cobalt oxide (LiCoO₂), lithium-manganese spinel (LiMn₂O₄), lithium nickel cobalt manganese oxide (NCM), for example LiNi_{0.333}Co_{0.333}Mn_{0.333}O₂, and mixtures thereof as electrochemically active material. In addition, the positive electrode can comprise a binder, known as an electrode binder. For example, the binder can comprise at least one polymer selected from the group consisting of polyvinylidene fluoride (PVdF), polyvinylidene-hexafluoropropylene copolymer (PVdF-HFP), cellulose or polystyrene-butadiene copolymer and mixtures thereof. For example, the binder can be an electrode binder based on polyvinylidene fluoride, polyvinylidene-hexafluoropropylene copolymer, cellulose and/or polystyrene-butadiene copolymer. The positive electrode can, for example, have a layer thickness d_{N} of from ≧40 μm to ≦600 μm, for example from ≧60 μm to ≦400 μm, for example about 200 μm.

For electrical contacting of the negative electrode and the positive electrode or for discharging and/or feeding electric current to and from the negative and positive electrodes, the electrochemical element can further comprise two contact elements, also referred to as power outlet foils or current collectors, to which the negative electrode or the positive electrode is applied in each case. In particular, the electrochemical element can have a contact element for electrically contacting the negative electrode and a contact element for electrically contacting the positive electrode. The contact elements for electrically contacting the negative and positive electrode can, for example, be metallic. In particular, the contact elements for electrically contacting the negative and positive electrodes can be metallic foils. For example, the contact element for electrically contacting the negative electrode can be made of copper and the contact element for electrically contacting the positive electrode can be made of aluminum.

For example, the electrochemical element can be a lithium ion wound cell or a lithium ion stack cell. In addition, the electrochemical element can be integrated into a housing, known as a hard case, for example a housing produced by deep drawing or extrusion, or a packing, known as a soft pack, for example a packing composed of a composite aluminum foil.

The present invention further provides a separator for an electrochemical element, in particular for a lithium ion cell, which comprises at least one inorganic solid-state electrolyte layer which conducts lithium ions. As regards the advantages of separators according to the invention, reference is hereby explicitly made to the explanations in connection with the electrochemical element of the invention.

The at least one inorganic solid-state electrolyte layer which conducts lithium ions can, in particular, not conduct electrons or be an insulator in respect of electrons and/or ceramic.

In a further embodiment, the at least one inorganic solid-state electrolyte layer which conducts lithium ions can be a lithium ion-conducting compound of the perovskite type, in particular a perovskite type having A vacancies.

In a further embodiment, the at least one inorganic solid-state electrolyte layer which conducts lithium ions comprises at least one lithium lanthanide titanate of the perovskite type (LLTO).

In a further embodiment, the at least one inorganic solid-state electrolyte layer which conducts lithium ions comprises at least one lithium lanthanide titanate of the perovskite type (LLTO) having the general formula (1):

Li₃ₐLn_{(2/3)-a(1/3)-2a}TiO₃ or Li₃ₐLn_{0.67-a}TiO₃,

where Ln is a lanthanide or a mixture of a plurality of lanthanides, in particular lanthanum, and 0<a≦0.16, in particular 0.04≦a≦0.15, preferably a=0.1 or a=0.11. For example, the at least one inorganic solid-state electrolyte layer which conducts lithium ions can comprise Li_{0.3}La_{0.57}TiO₃.

Lithium lanthanum titanates of the perovskite type can, for example, be prepared in a solid-state synthesis, for example from Li₂CO₃, La₂O₃ and TiO₂ (anatase), at temperatures above 600° C., for example firstly at 650° C. for 2 hours and subsequently at 800° C. for 12 hours. The product can subsequently be milled and pressed. The product is then preferably sintered/heat treated, for example at 1300° C. for 1 hour. The lithium ion conductivity can advantageously be increased by the heat treatment. Lithium lanthanum titanates of the perovskite type which have been prepared in this way are preferably quenched, i.e. cooled rapidly, after the heat treatment. The lithium ion conductivity can be increased further in this way.

However, lithium lanthanum titanates of the perovskite type can also be prepared in a sol-gel synthesis, for example from La(NO₃)₃.6H₂O and LiNO₃ in water and Ti(OC₃H₇)₄ in 1-propanol, for example firstly at 700° C. for gel formation, subsequently at 95° C. for 5 hours and/or at 100° C. for 12 hours for drying, then at 400-700° C. for 12 hours for decomposition. The product is then preferably sintered/heat treated, for example at 1300° C. for 1 hour. The lithium ion conductivity can advantageously be increased by the heat treatment. Lithium lanthanum titanates of the perovskite type which have been prepared in this way are preferably cooled slowly, for example at a cooling rate of 100° C./h, after the heat treatment. The lithium ion conductivity can be increased further in this way.

As an alternative or in addition, the at least one inorganic solid-state electrolyte layer which conducts lithium ions can comprise a lithium ion-conducting compound of the NASICON type (NASICON: “sodium super-ionic conductor”). In particular, the at least one inorganic solid-state electrolyte layer which conducts lithium ions can be a lithium ion-conducting compound of the NASICON type having the general formula (2):

A_{1+b}[M¹_{2-b}M²_{b}(PO₄)₃]

where
A is a monovalent element or a mixture of a plurality of monovalent elements, in particular Li and/or Na,
M¹ is a tetravalent element or a mixture of tetravalent elements, in particular Ge, Ti, Zr or a mixture thereof,
M² is a trivalent element or a mixture of trivalent elements, in particular Al, Cr, Ga, Fe, Sc, In, Lu, Y, La or a mixture thereof,
   and 0≦b≦1. Examples are LiGe₂ (PO₄)₃ and Li_{1.3}Al_{0.3}Ti_{2.7}(PO₄)₃ (LATP). The lithium ion conductivity can be increased by, in particular, trivalent cations which are smaller than aluminum ions.

As an alternative or in addition, the at least one inorganic solid-state electrolyte layer which conducts lithium ions can comprise a lithium ion-conducting compound of the LiSICON type (LiSICON: “lithium super-ionic conductor”) or the thio-LiSICON type or of the γ-Li₃PO₄ type. For example, the at least one inorganic solid-state electrolyte layer which conducts lithium ions can be a lithium germanate, in particular of the general formula (3): Li_{2+2c}Zn_{1-c}GeO₄ where 0<c<1, for example Li₁₄ZnGe₄O₁₆, and/or a lithium germanium sulfide, in particular of the Li₂S—Ga₂S₃—GeS₂ type or of the general formula (4): Li_{4+d}Ge_{1-d}Ga_{d}S₄ where 0.15≦d≦0.35, and/or a lithium germanium/silicon/phosphorus sulfide, in particular of the general formula (5): Li₄₋ₑ(Ge/Si)₁₋ₑPₑS₄ where 0.5≦e≦1, for example Li_{3.25}Ge_{0.25}P_{0.75}S₄ or Li_{3.4}Si_{0.4}P_{0.6}S₄ (6.4·10⁻⁴ S/cm).

As an alternative or in addition, the at least one inorganic solid-state electrolyte layer which conducts lithium ions can comprise a lithium ion-conducting compound of the garnet type. In particular, the at least one inorganic solid-state electrolyte layer which conducts lithium ions can be a lithium ion-conducting compound of the garnet type having the general formula (7):

Li_{5+f+2g}Ln_{3-f}M³_{f}M⁴_{g}M⁵_{2-g}O₁₂

where
Ln is a lanthanide or a mixture of a plurality of lanthanides, in particular La, Pr, Nd, Sm, Eu or a mixture thereof,
M³ is a divalent element or a mixture of a plurality of divalent elements, in particular Ba, Sr, Ca or a mixture thereof,
M⁴ is a trivalent element or a mixture of a plurality of trivalent elements, in particular indium,
M⁵ is a pentavalent element or a mixture of a plurality of trivalent elements, in particular Ta, Nb, Sb or a mixture thereof,
   and 0≦f≦1 and 0≦g≦0.35.

For example, the at least one inorganic solid-state electrolyte layer which conducts lithium ions can comprise Li₅La₃Ta₂O₁₂, Li₆La₂BaTa₂O₁₂, Li_{5.5}La₃Nb_{1.75}In_{0.25}O₁₂, Li₅ (La/Pr/Nd/Sm/Eu)₃Sb₂O₁₂ and/or Li₆Sr(La/Pr/Nd/Sm/Eu)₂Sb₂O₁₂.

As an alternative or in addition, the at least one inorganic solid-state electrolyte layer which conducts lithium ions can comprise a lithium ion-conducting composite. In particular, the at least one inorganic solid-state electrolyte layer which conducts lithium ions can comprise a lithium ion-conducting composite composed of at least one lithium ion-conducting compound, for example LiI and/or Li₂O, and at least one, in particular mesoporous, compound which does not conduct lithium ions, for example Al₂O₃ and/or B₂O₃.

As an alternative or in addition, the at least one inorganic solid-state electrolyte layer which conducts lithium ions can comprise an amorphous, inorganic lithium ion-conducting compound. In particular, the at least one inorganic solid-state electrolyte layer which conducts lithium ions can comprise a mechanically treated, in particular (ball-)milled, amorphous, inorganic, lithium ion-conducting compound, for example ball-milled LiNbO₃ or LiTaO₃. As an alternative thereto or in addition thereto, the at least one inorganic solid-state electrolyte layer which conducts lithium ions can comprise a lithium ion-conducting, oxideand/or sulfur-based glass, for example GeS₂—Li₂S—LiI doped with Ga₂S₃ and/or LaS₃ or Li₂S—SiS₂ doped with P₂S₅ and/or LiI and/or Li₄SiO₄.

As an alternative or in addition, the at least one inorganic solid-state electrolyte layer which conducts lithium ions can comprise a lithium ion-conducting compound of the LiPON type (LiPON: “lithium phosphorus oxynitride”), for example Li_{2.88}PO_{3.73}N_{0.14}, Li_{3.0}PO_{2.0}N_{1.2}, or a lithium ion-conducting compound of the LiSON type (LiSON: “lithium sulfur oxynitride”), for example Li_{0.29}S_{0.28}O_{0.35}N_{0.09}, or a lithium ion-conducting compound of the LiPOS type (LiPOS: “lithium phosphorus oxysulfide”), for example 6LiI-4Li₃PO₄—P₂S₅, or a lithium ion-conducting compound of the LiBSO type (LiBSO: “lithium borate sulfate” or “lithium borate-lithium sulfate glass”), for example of the general formula (8): (1−h)LiBO₂-hLi₂SO₄, where 0<h<1, for example 0.3LiBO₂-0.7Li₂SO₄, or a lithium ion-conducting compound of the LiSIPON type (LiSIPON: “lithium silicon phosphorus oxynitride”), for example Li_{2.9}Si_{0.45}PO_{1.6}N1.3₄.

In particular, the at least one inorganic solid-state electrolyte layer which conducts lithium ions can be porous. For example, the at least one inorganic solid-state electrolyte layer which conducts lithium ions can have a porosity, in particular an open porosity, of from ≧5% to ≦90%, for example from ≧25% to ≦75%, for example about 50%.

For example, the at least one inorganic solid-state electrolyte layer which conducts lithium ions can have a layer thickness d_{F} of from ≧0.1 μm to ≦50 μm, for example from ≧0.5 μm to ≦15 μm, for example about 5 μm.

The at least one inorganic solid-state electrolyte layer which conducts lithium ions preferably has a lithium ion conductivity at room temperature of at least 1·10⁻⁷ S/cm, in particular at least 1·10⁻⁶ S/cm, for example at least 1·10⁻⁵ S/cm or 1·10⁻⁴ S/cm, preferably at least 5·10⁻⁴ S/cm, for example at least 1·10⁻³ S/cm.

Furthermore, the separator preferably comprises at least one polymer layer. The polymer layer can, by way of example, be a polyolefin-based polymer layer. The mechanical stability of the separator can be increased advantageously and cost-effectively by means of an additional polymer layer. Thus, the material of the inorganic solid-state electrolyte layer which conducts lithium ions and the associated materials costs can once again be minimized. In addition, polymer layers can advantageously have a high chemical and/or electrochemical long-term stability (over years) and thus increase the overall mechanical, chemical and electrochemical stability of the separator. Furthermore, such a separator can be produced in a simple way by coating a polymer layer with an inorganic solid-state electrolyte layer which conducts lithium ions or by coating an inorganic solid-state electrolyte layer which conducts lithium ions with a polymer layer. In addition, the polymer layer can be porous. The porosity of polymer layers can advantageously be set in a defined manner in a simple way, for example by means of a stretching process. The polymer layer can also conduct lithium ions. The polymer layer preferably does not conduct electrons. For example, the polymer layer can have a layer thickness d_{F} of from ≧1 μm to ≦100 μm, for example from ≧10 μm to ≦40 μm, for example about 25 μm.

The separator is preferably configured so that a negative electrode and a positive electrode can be physically separated from one another by the at least one inorganic solid-state electrolyte layer which conducts lithium ions. For example, the at least one inorganic solid-state electrolyte layers which conducts lithium ions can for this purpose have the same area as the negative electrode and the positive electrode and is able to be arranged parallel to these surfaces between the negative electrode and the positive electrode. In particular, the separator can be configured and arranged so that a negative electrode and a positive electrode can be physically separated from one another by the at least one inorganic solid-state electrolyte layer which conducts lithium ions and the at least one polymer layer. For example, both the at least one inorganic solid-state electrolyte layer which conducts lithium ions and the at least one polymer layer can have the same areas as the negative electrode and the positive electrode and in each case are able to be arranged parallel to these surfaces between the negative electrode and positive electrode.

In a further embodiment, the separator comprises a layer system composed of at least one inorganic solid-state electrolyte layer which conducts lithium ions and at least one polymer layer. For example, the layers can be arranged alternately. The at least one inorganic solid-state electrolyte layer which conducts lithium ions is preferably arranged between the polymer layer and at least one of the electrodes, in particular the positive electrode. In particular, the polymer layer can be provided on one or both sides with in each case at least one inorganic solid-state electrolyte layer which conducts lithium ions. The polymer layer is preferably provided with an inorganic solid-state electrolyte layer which conducts lithium ions on at least the side which faces the positive electrode. In particular, the separator can comprise a layer system composed of at least one inorganic solid-state electrolyte layer which conducts lithium ions and at least two polymer layers, with at least one inorganic solid-state electrolyte layer which conducts lithium ions being arranged between two polymer layers.

The present invention further provides for the use of a separator according to the invention in an electrochemical element, in particular in a lithium ion cell.

### DRAWINGS AND EXAMPLES

Further advantages and advantageous embodiments of the subject matter of the invention are illustrated by the drawings and explained in the following description. It should be noted that the drawings are only descriptive in character and are not intended to restrict the invention in any way. The figures show:

FIG. 1 a schematic cross section through a first embodiment of a lithium ion cell according to the invention;

FIG. 2 a schematic cross section through a second embodiment of a lithium ion cell according to the invention;

FIG. 3 a schematic cross section through a third embodiment of a lithium ion cell according to the invention;

FIG. 4 a schematic cross section through a fourth embodiment of a lithium ion cell according to the invention;

FIG. 5 a schematic cross section through a layer of an inorganic material which does not conduct lithium ions; and

FIG. 6 a schematic cross section through an inventive, inorganic solid-state electrolyte layer which conducts lithium ions.

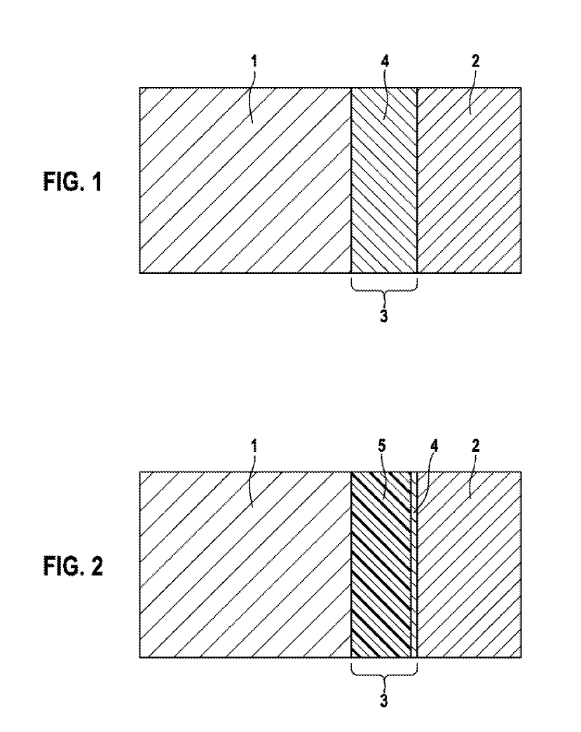

FIG. 1 shows that the lithium ion cell comprises a negative electrode (anode) 1, a positive electrode (cathode) 2 and a separator 3 arranged between the negative electrode 1 and the positive electrode 2. The negative electrode 1 is an intercalation electrode and comprises, in the unactivated state after production, the intercalation material, for example graphite, but no metallic lithium. Only during activation of the lithium ion cell do lithium ions penetrate into the intercalation material of the negative electrode and lithiate the intercalation material (in this context, the material is referred to as, for example, lithiated graphite). In other words, the negative electrode 1 does not comprise metallic lithium, in contrast to the negative electrodes of known lithium-sulfur cells. The positive electrode 2 can comprise, for example, lithium cobalt oxide (LiCoO₂), lithium-manganese spinel (LiMn₂O₄), lithium nickel cobalt manganese oxides (NCM) and mixtures thereof as electrochemical active material. In addition, the negative electrode 1 and positive electrode 2 can comprise a polymeric electrode binder.

In the first embodiment, shown in FIG. 1, the separator 3 comprises an inorganic solid-state electrolyte layer 4 which does not conduct electrons but conducts lithium ions. In this embodiment, an additional polymer layer as separator membrane can advantageously be dispensed with. This embodiment has been found to be particularly advantageous for lithium ion stack cells.

The second embodiment shown in FIG. 2 differs from the first embodiment shown in FIG. 1 in that the separator has a layer system composed of an inorganic solid-state electrolyte layer 4 which conducts lithium ions and a polymer layer 5. In particular, the polymer layer 5 is provided with the inorganic solid-state electrolyte layer 4 which conducts lithium ions on the side facing the positive electrode 2.

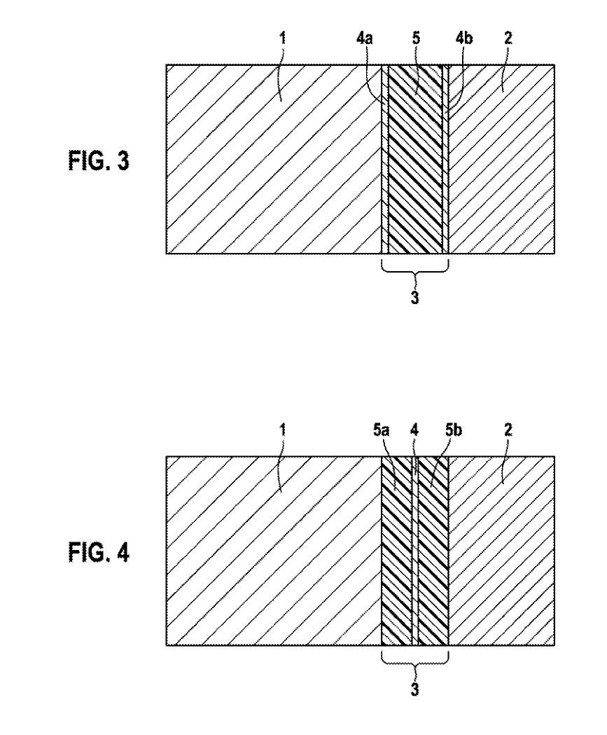

The third embodiment shown in FIG. 3 differs from the second embodiment shown in FIG. 2 in that the separator has a layer system composed of two inorganic solid-state electrolyte layers 4a, 4b which conduct lithium ions and a polymer layer 5. In particular, the polymer layer 5 is provided on both sides with an inorganic solid-state electrolyte layer 4a, 4b which conducts lithium ions. In this way, the “breakthrough reliability” or the mechanical puncture resistance can advantageously be increased further.

The fourth embodiment shown in FIG. 4 differs from the third embodiment shown in FIG. 3 in that the separator has a layer system composed of an inorganic solid-state electrolyte layer 4 which conducts lithium ions and two polymer layers 5a, 5b, with the inorganic solid-state electrolyte layer 4 which conducts lithium ions being arranged between the two polymer layers 5a, 5b. In this way, chemical reactions between the inorganic solid-state electrolyte layer 4 which conducts lithium ions and the materials of the electrodes 1, 2 can be avoided and the “breakthrough reliability” can be increased.

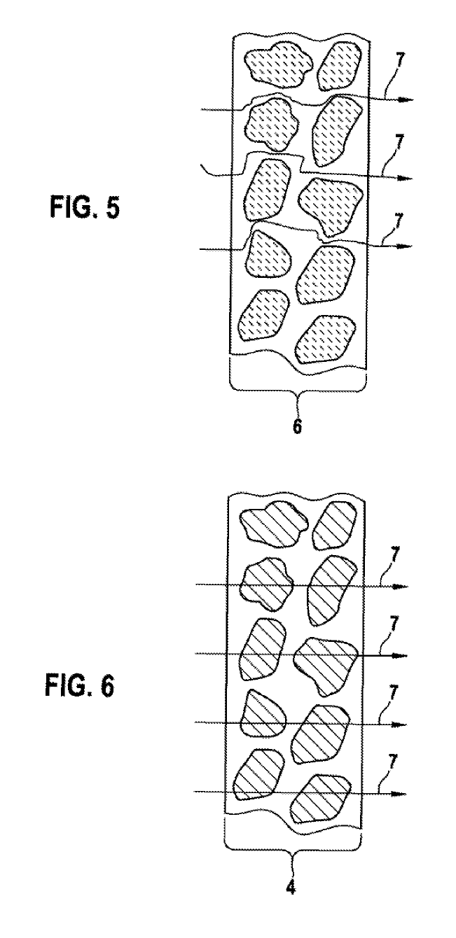

FIG. 5 shows that in the case of a conventional layer 6 composed of an inorganic material which does not conduct lithium ions, for example aluminum oxide (Al₂O₃), lithium ions have to diffuse around the inorganic material which does not conduct lithium ions. This results in relatively long diffusion paths 7.

FIG. 6 shows that in the case of an inventive inorganic solid-state electrolyte layer 4 which conducts lithium ions, for example La_{0.57}Li_{0.3}TiO₃, lithium ions can diffuse through the lithium ion-conducting material of the solid-state electrolyte layer 4. In this way, the diffusion paths for the lithium ions can advantageously be shortened, which has, inter alia, an advantageous effect on the internal resistance and the high-current capability of the lithium ion cell.

Table 1 shows the behavior of three different lithium ion cells which have identical electrodes, polymer separator layers and electrolyte formulations, in particular formulations based on LiPF₆, but differ in terms of the type and presence of an inorganic layer. All cells were activated and discharged at 1C (1-hour discharge) in order to determine the nominal capacity. LiNi_{0.333}CO_{0.333}Mn_{0.333}O₂ was used as electrochemical active material for the positive electrodes. Synthetic graphite was used as intercalation material for the negative electrodes.

TABLE 1

| | | 1 C | 3 C | |
|---|---|---|---|---|
| | | Discharge | Discharge | Impedance |
| | Inorganic | capacity | capacity | (1 kHz) |
| | layer | [Ah] | [Ah] | [mΩ] |
| Cell 1 | Al₂O₃ | 5.00 Ah | 4.32 Ah | 6.62 |
| Cell 2 | none | 5.00 Ah | 4.48 Ah | 6.30 |
| Cell 3 | La_{0.57}Li_{0.3}TiO₃ | 5.00 Ah | 4.50 Ah | 6.25 |
| (according to | | | | |
| the invention) | | | | |

It can be seen that the discharge capacity at a 1C discharge was the same for all cells. At a 3C discharge, on the other hand, the cells had different discharge capacities. The 3C discharge capacity of the lithium ion cell 1 according to the invention having an inorganic solid-state electrolyte layer which conducts lithium ions was significantly higher than the 3C discharge capacity of the lithium ion cell 3 having an inorganic layer which does not conduct lithium ions and virtually identical to the 3C discharge capacity of the lithium ion cell 2 which had no inorganic layer.

Table 2 shows the results of a safety test, in particular an oven test in accordance with UL 1642 with the parameters: T=130° C., SOC=100% for 10 minutes with discharge of in each case 50 cells.

TABLE 2

| | | Results of the oven |
|---|---|---|
| | | test in accordance |
| | | with UL 1642 |
| | Inorganic layer | (50 cells tested) |
| Cell 1 | Al₂O₃ | 50/50 ok |
| Cell 2 | none | 31/50 ok |
| Cell 3 | La_{0.57}Li_{0.3}TiO₃ as | 50/50 ok |
| (according to the | per [6] | |
| invention) | | |

The results of the oven test in accordance with UL 1642 show that a protective action which is as good as that of an aluminum oxide layer can be achieved by means of an inventive, inorganic solid-state electrolyte layer which conducts lithium ions.

1. A lithium ion cell comprising:
a negative electrode;
a positive electrode; and
a separator arranged between the negative electrode and the positive electrode, and including at least one inorganic solid-state electrolyte layer which conducts lithium ions.

2. The lithium ion cell as claimed in claim 1, wherein the at least one inorganic solid-state electrolyte layer which conducts lithium ions does not conduct electrons.

3. The lithium ion cell as claimed in claim 1, wherein the at least one inorganic solid-state electrolyte layer which conducts lithium ions comprises at least one lithium ion-conducting compound selected from the group consisting of lithium ion-conducting compounds of the perovskite type, lithium ion-conducting compounds of the NASICON type, lithium ion-conducting compounds of the LiSICON type, lithium ion-conducting compounds of the thio-LiSICON type, lithium ion-conducting compounds of the garnet type, lithium ion-conducting composites, amorphous, inorganic lithium ion-conducting compounds, lithium ion-conducting compounds of the LiPON type, lithium ion-conducting compounds of the LiSON type, lithium ion-conducting compounds of the LiPOS type, lithium ion-conducting compounds of the LiBSO type, lithium ion-conducting compounds of the LiSIPON type, and mixtures thereof.

4. The lithium ion cell as claimed in claim 1, wherein the at least one inorganic solid-state electrolyte layer which conducts lithium ions includes at least one lithium lanthanide titanate of the perovskite type, having the general formula (1):
Li₃ₐLn_{0.67-a}TiO₃,
where Ln is lanthanum, and 0.04≦a≦0.15.

5. The lithium ion cell as claimed in claim 1, wherein the at least one inorganic solid-state electrolyte layer which conducts lithium ions is porous and has a porosity of from ≧5% to ≦90%.

6. The lithium ion cell as claimed in claim 1, wherein the at least one inorganic solid-state electrolyte layer which conducts lithium ions has a lithium ion conductivity at room temperature of at least 5·10⁻⁴ S/cm.

7. The lithium ion cell as claimed in claim 1, wherein the separator includes a layer system composed of at least one inorganic solid-state electrolyte layer which conducts lithium ions and at least one polymer layer.

8. The lithium ion cell as claimed in claim 1, wherein the separator includes at least one polymer layer which has an inorganic solid-state electrolyte layer that conducts lithium ions on at least the side facing the positive electrode.

9. The lithium ion cell as claimed in claim 1, wherein the negative electrode includes natural or synthetic graphite, carbon nanotubes, soft carbons and/or hard carbons, as an intercalation material.

10. A separator for a lithium ion cell, comprising:
a layer system includes (i) at least one inorganic solid-state electrolyte layer which conducts lithium ions and (ii) at least one polymer layer.

11. The separator as claimed in claim 10, wherein:
the at least one inorganic solid-state electrolyte layer which conducts lithium ions includes a lithium ion-conducting compound
wherein the lithium ion-conducting compound is a lithium lanthanide titanate of the perovskite type, and
wherein the lithium ion-conducting compound has the general formula:
Li₃ₐLn_{(2/3)-a□(1/3)-2a}TiO₃ or Li₃ₐLn_{0.67-a}TiO₃,
where Ln is lanthanum, and 0.04≦a≦0.15.

12. The separator as claimed in claim 10, wherein the separator is used in a lithium ion cell.
